(19) United States
(12) Patent Application Publication
(10) Pub. No.: US 2026/0011947 A1
(43) Pub. Date: Jan. 8, 2026

(54) Terminal, Electrical Connection Module And Connector

(71) Applicant: Tyco Electronics (Shanghai) Co., Ltd., Shanghai (CN)

(72) Inventors: Dingbing (Frank) Fan, Shanghai (CN); Ming Shi, Shanghai (CN); Xiaozhi (George) Fu, Shanghai (CN); Wei Zhang, Shanghai (CN); Zhao Cheng, Shanghai (CN); Lei (Louis) Liu, Shanghai (CN)

(73) Assignee: Tyco Electronics (Shanghai) Co., Ltd., Shanghai (CN)

(21) Appl. No.: 19/259,513

(22) Filed: Jul. 3, 2025

(30) Foreign Application Priority Data
Jul. 5, 2024 (CN) 202421593984.4

(51) Int. Cl. H01R 13/432; H01R 13/11

(52) U.S. Cl. CPC H01R 13/432; H01R 13/11

(57) ABSTRACT

A terminal includes a mating portion for mating with a mating terminal and a guide plate. The mating portion includes a top wall, a bottom wall opposite the top wall in a height direction of the mating portion, and a pair of side walls opposite in a transverse direction of the mating portion. The guide plate is connected to a side of the top wall and guides insertion of the terminal into a terminal insertion hole of a connector housing in a correct orientation. A step portion adapted to abut against a secondary lock of a connector is formed at a rear end of the mating portion. The guide plate is located above and perpendicular to the top wall. A rear end of one of the side walls engages a rear end of the guide plate and/or a rear end of the top wall.

### CROSS-REFERENCE TO RELATED APPLICATION

This application claims the benefit of the filing date under 35 U.S.C. § 119 (a)-(d) of Chinese Patent Application No. 202421593984.4, filed on Jul. 5, 2024.

### FIELD OF THE INVENTION

The present invention relates to a terminal, an electrical connection module including the terminal, and a connector including the electrical connection module.

### BACKGROUND OF THE INVENTION

A connector generally includes a housing, a terminal and a secondary lock. A terminal insertion hole is formed in the housing, and the terminal is inserted and mounted into the terminal insertion hole. A secondary lock slot is also formed in the housing, and the secondary lock is inserted and mounted into the secondary lock slot. The secondary lock mounted in the housing abuts against a step portion at a rear end of a mating portion of the terminal to lock the terminal in the housing. The rear end of the existing mating portion has an annular structure with an open side, however, resulting in poor structural strength and easy deformation. This causes the terminal to easily disengage from the secondary lock.

### SUMMARY OF THE INVENTION

A terminal includes a mating portion for mating with a mating terminal and a guide plate. The mating portion includes a top wall, a bottom wall opposite the top wall in a height direction of the mating portion, and a pair of side walls opposite in a transverse direction of the mating portion. The guide plate is connected to a side of the top wall and guides insertion of the terminal into a terminal insertion hole of a connector housing in a correct orientation. A step portion adapted to abut against a secondary lock of a connector is formed at a rear end of the mating portion. The guide plate is located above and perpendicular to the top wall. A rear end of one of the side walls engages a rear end of the guide plate and/or a rear end of the top wall.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a terminal according to an exemplary embodiment of the present invention, viewed from a side;

FIG. 2 shows an illustrative perspective view of the terminal according to an exemplary embodiment of the present invention, viewed from another side;

FIG. 3 shows a longitudinal cross-sectional view of the terminal according to an exemplary embodiment of the present invention;

FIG. 4 shows an illustrative perspective view of a connector according to an exemplary embodiment of the present invention;

FIG. 5 shows an exploded schematic view of the connector according to an exemplary embodiment of the present invention;

FIG. 6 shows an illustrative perspective view of a terminal according to another exemplary embodiment of the present invention, viewed from a side;

FIG. 7 shows an illustrative perspective view of the terminal according to another exemplary embodiment of the present invention, viewed from another side;

FIG. 8 shows a longitudinal cross-sectional view of the terminal according to another exemplary embodiment of the present invention;

FIG. 9 shows an illustrative perspective view of a connector according to another exemplary embodiment of the present invention; and

FIG. 10 shows an exploded schematic view of the connector according to another exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### The First Embodiment

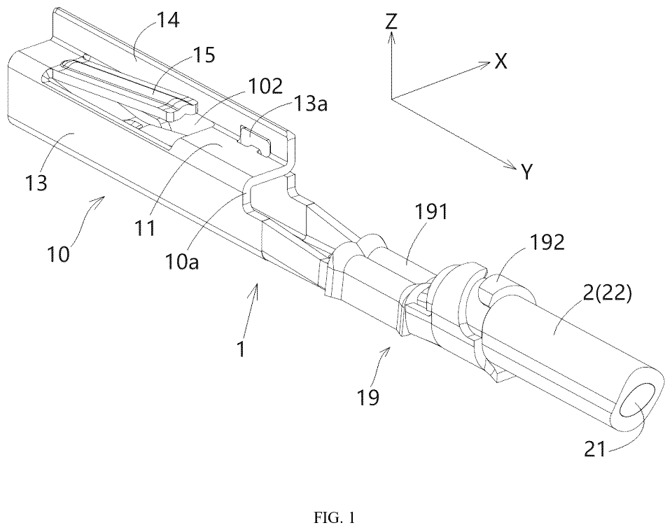

As shown in FIGS. 1 to 5, in an exemplary embodiment of the present invention, a terminal 1 is disclosed. The terminal 1 includes a mating portion 10 and a guide plate 14. The mating portion 10 is used for mating with a mating terminal. The mating portion 10 includes a top wall 11 and a bottom wall 12 opposite in a height direction Z thereof, and a pair of side walls 13 opposite in a transverse direction X thereof. The guide plate 14 is connected to a side of the top wall 11 and extends in a longitudinal direction Y of the mating portion 10 for guiding the insertion of the terminal 1 into a terminal insertion hole 301 of a connector housing 3 in a correct orientation.

As shown in FIG. 1, in the illustrated embodiment, a step portion 10a adapted to abut against a secondary lock 4 of a connector is formed at a rear end of the mating portion 10, so as to enable the terminal 1 to be locked in the terminal insertion hole 301 by the secondary lock 4. The guide plate 14 is located above and perpendicular to the top wall 11, a rear end of one side wall 13 on one side of the top wall 11 engages a rear end of the guide plate 14 and/or a rear end of the top wall 11, so as to enhance the structural strength of the rear end of the mating portion 10.

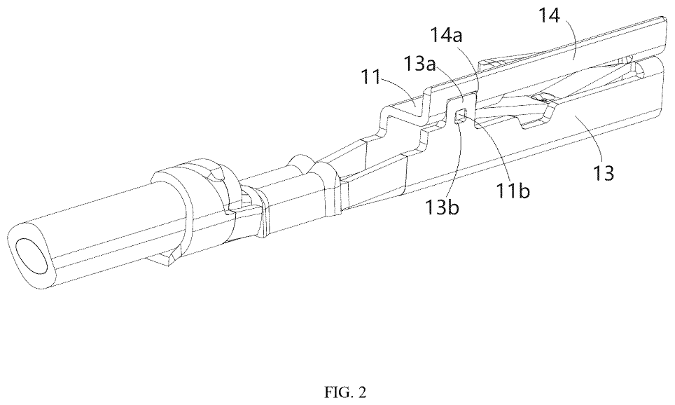

As shown in FIGS. 1 and 2, in the illustrated embodiment, a snap 13a is formed on the rear end of the one side wall 13, the snap 13a protrudes upward from an upper side edge of the one side wall 13, a snap slot 14a is formed in the rear end of the guide plate 14, and the snap 13a is latched into the snap slot 14a to engage the rear end of the one side wall 13 with the rear end of the guide plate 14.

In the illustrated embodiment, the snap 13a and the snap slot 14a are rectangular, an engagement hole 13b is formed in the snap 13a, an engagement post 11b is formed on a side of the rear end of the top wall 11, and the engagement post 11b is inserted into the engagement hole 13b to engage the rear end of the one side wall 13 with the rear end of the top wall 11.

As shown in FIG. 1, in the illustrated embodiment, the terminal 1 further includes a locking tab 15 connected to a front end of the top wall 11 and extending obliquely upward and rearward for engaging with a hole wall of the terminal insertion hole 301 to lock the terminal 1 in the terminal insertion hole 301.

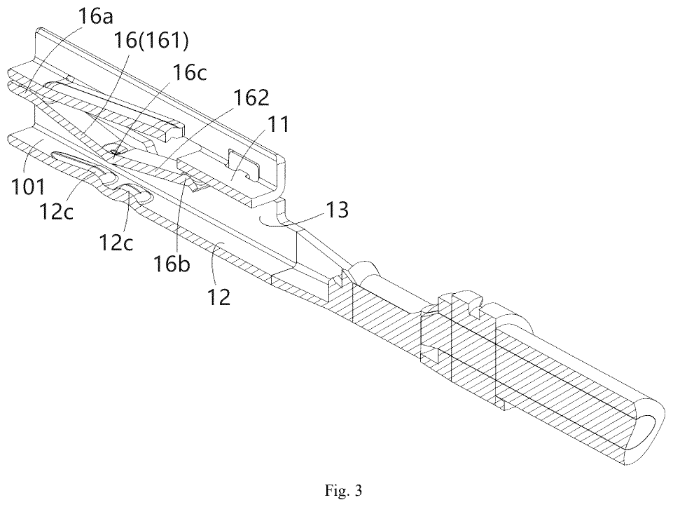

As shown in FIG. 1, in the illustrated embodiment, an opening 102 is formed in the top wall 11 of the mating portion 10, and the locking tab 15 is suspended in the opening 102 to allow the locking tab 15 to move elastically in the height direction Z of the mating portion 10. The top wall 11, the bottom wall 12 and the pair of side walls 13 of the mating portion 10 define an insertion cavity 101 for insertion of the mating terminal, shown in FIG. 3. The bottom wall 12 is connected between lower side edges of the pair of side walls 13, and the other side of the top wall 11 is connected to an upper side edge of the other side wall 13.

As shown in FIG. 3, in the illustrated embodiment, the terminal 1 further includes a resilient cantilever 16 located in the insertion cavity 101 of the mating portion 10 and having a fixed end 16a connected to an inner side of a front end of one of the pair of side walls 13. The resilient cantilever 16 is used for electrical contact with the mating terminal inserted into the insertion cavity 101 of the mating portion 10.

As shown in FIG. 3, in the illustrated embodiment, a free end 16b of the resilient cantilever 16 abuts against an inner side of the rear end of the top wall 11, and a first electrical contact 16c is formed on the resilient cantilever 16, the first electrical contact 16c is used for electrical contact with a side of the inserted mating terminal. In the illustrated embodiment, the resilient cantilever 16 is V-shaped, and includes a first arm portion 161 extending between the fixed end 16a and the first electrical contact 16c and a second arm portion 162 extending between the free end 16b and the first electrical contact 16c.

As shown in FIG. 3, in the illustrated embodiment, two raised second electrical contacts 12c are formed on an inner side of the bottom wall 12 of the mating portion 10, and the two second electrical contacts 12c are both in electrical contact with a side of the inserted mating terminal. In the illustrated embodiment, the two second electrical contacts 12c are spaced apart in the longitudinal direction Y of the mating portion 10, and the first electrical contact 16c is located between the two second electrical contacts 12c.

As shown in FIG. 1, in the illustrated embodiment, the terminal 1 further includes a crimping portion 19 for crimping onto a cable 2, wherein the crimping portion 19 is connected to the rear end of the mating portion 10 and extends rearward. In the illustrated embodiment, the crimping portion 19 includes a first crimping portion 191 and a second crimping portion 192. The first crimping portion 191 is used for crimping onto a conductor core 21 of the cable 2. The second crimping portion 192 is used for crimping onto an outer sheath 22 of the cable 2. The first crimping portion 19 is located between the mating portion 10 and the second crimping portion 192.

In the illustrated embodiment, the terminal 1 is a one-piece stamped part.

In another exemplary embodiment of the present invention, an electrical connection module is also disclosed. The electrical connection module includes a terminal 1 and a cable 2. The cable 2 has an end electrically connected to the terminal 1.

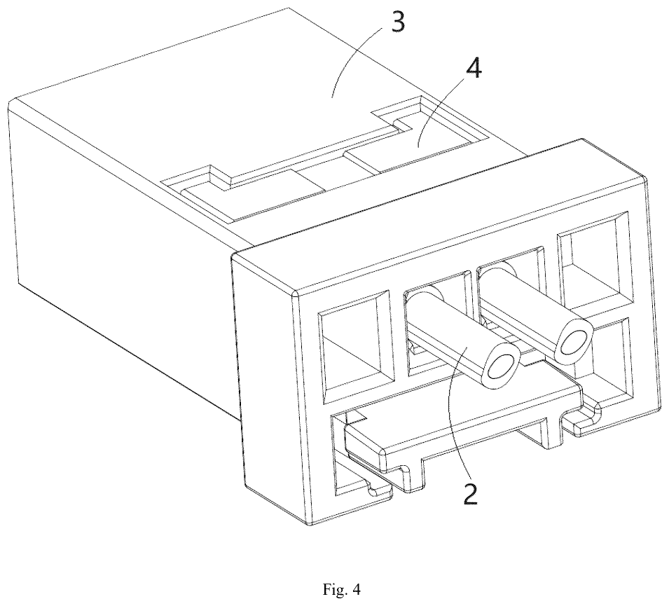

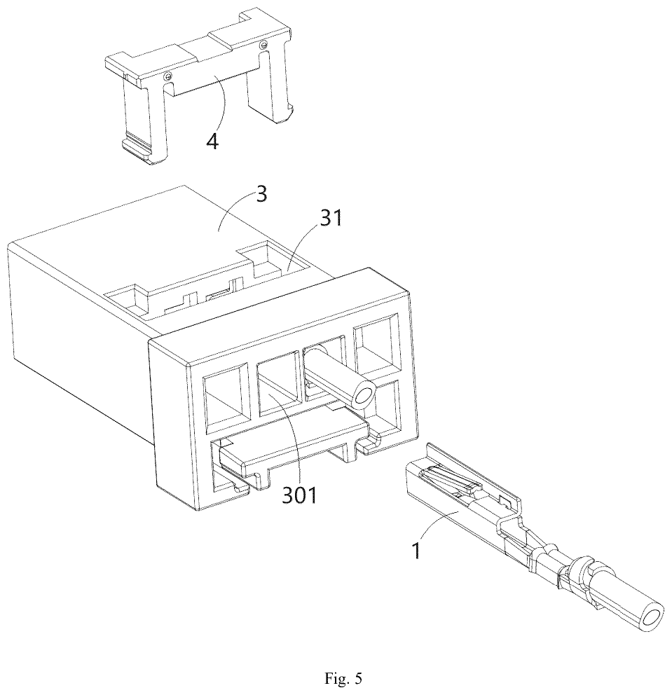

As shown in FIGS. 4 and 5, in another exemplary embodiment of the present invention, a connector is also disclosed. The connector includes a connector housing 3, a secondary lock 4 and the above terminal 1 or electrical connection module. The connector housing 3 has a terminal insertion hole 301 extending in a longitudinal direction Y thereof and a secondary lock slot 31 extending in a transverse direction X thereof and in communication with the terminal insertion hole 301. The terminal 1 or electrical connection module is inserted and mounted into the terminal insertion hole 301. The secondary lock 4 is inserted and mounted into the secondary lock slot 31 and abuts against the step portion 10a at the rear end of the mating portion 10 of the terminal 1 in the longitudinal direction Y to lock the terminal 1 in the terminal insertion hole 301.

In an embodiment, a guide groove extending in the longitudinal direction Y of the housing 3 is formed in the housing 3, the guide groove is used for cooperating with the guide plate 14 on the terminal 1 to guide the insertion and mounting of the terminal 1 into the terminal insertion hole 301 of the connector housing 3 in a correct orientation.

As shown in FIG. 5, in the illustrated embodiment, a plurality of terminal insertion holes 301 are formed in the connector housing 3, and the secondary lock slot 31 is in communication with the plurality of terminal insertion holes 301. The connector includes a plurality of terminals 1, the plurality of terminals 1 are respectively inserted and mounted into the plurality of terminal insertion holes 301, and the secondary lock 4 is adapted to abut against all of the plurality of terminals 1 to lock all of the plurality of terminals 1 in the terminal insertion holes 301.

### The Second Embodiment

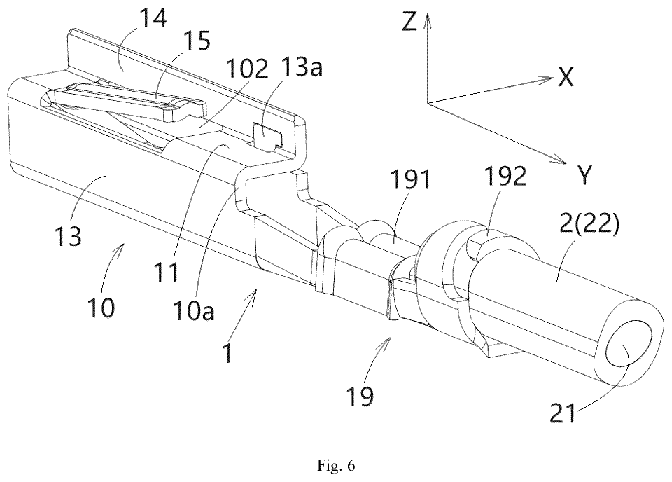

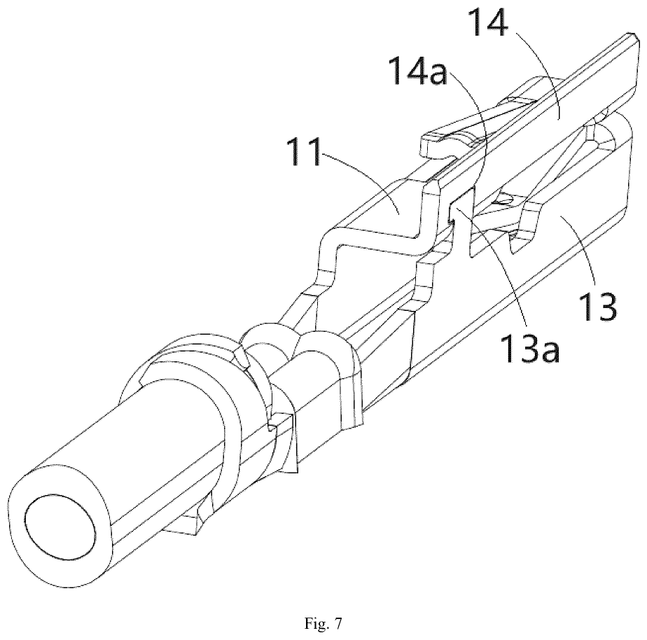

As shown in FIGS. 6 to 10, in an exemplary embodiment of the present invention, a terminal 1 is disclosed. The terminal 1 includes a mating portion 10 and a guide plate 14. The mating portion 10 is used for mating with a mating terminal. The mating portion 10 includes a top wall 11 and a bottom wall 12 opposite in a height direction Z thereof, and a pair of side walls 13 opposite in a transverse direction X thereof. The guide plate 14 is connected to a side of the top wall 11 and extends in a longitudinal direction Y of the mating portion 10 for guiding the insertion of the terminal 1 into a terminal insertion hole 301 of a connector housing 3 in a correct orientation.

As shown in FIG. 6, in the illustrated embodiment, a step portion 10a adapted to abut against a secondary lock 4 of a connector is formed at a rear end of the mating portion 10, so as to enable the terminal 1 to be locked in the terminal insertion hole 301 by the secondary lock 4. The guide plate 14 is located above and perpendicular to the top wall 11, a rear end of one side wall 13 on one side of the top wall 11 engages a rear end of the guide plate 14 and/or a rear end of the top wall 11, so as to enhance the structural strength of the rear end of the mating portion 10.

As shown in FIGS. 6 to 8, in the illustrated embodiment, a snap 13a is formed on the rear end of the one side wall 13, the snap 13a protrudes upward from an upper side edge of the one side wall 13, a snap slot 14a is formed in the rear end of the guide plate 14, and the snap 13a is latched into the snap slot 14a to engage the rear end of the one side wall 13 with the rear end of the guide plate 14. In the illustrated embodiment, the snap 13a and the snap slot 14a are L-shaped, T-shaped or Q-shaped, such that the snap 13a and the snap slot 14a latched together are prevented from disengaging in the longitudinal direction Y and the height direction Z of the mating portion 10.

As shown in FIG. 6, in the illustrated embodiment, the terminal 1 further includes a locking tab 15 connected to a front end of the top wall 11 and extending obliquely upward and rearward for engaging with a hole wall of the terminal insertion hole 301 to lock the terminal 1 in the terminal insertion hole 301. In the illustrated embodiment, an opening 102 is formed in the top wall 11 of the mating portion 10, and the locking tab 15 is suspended in the opening 102 to allow the locking tab 15 to move elastically in the height direction Z of the mating portion 10.

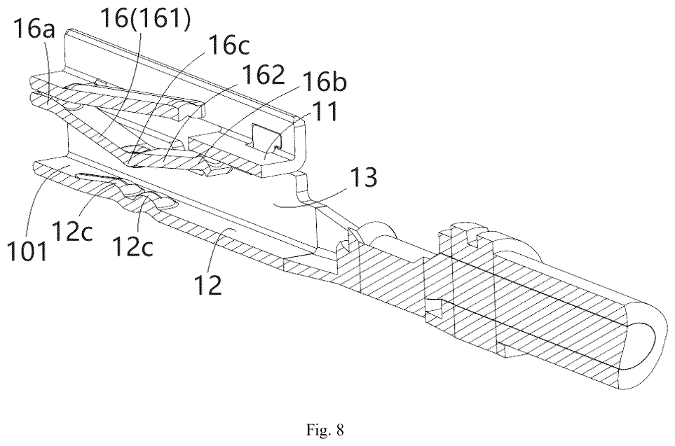

As shown in FIG. 8, in the illustrated embodiment, the top wall 11, the bottom wall 12 and the pair of side walls 13 of the mating portion 10 define an insertion cavity 101 for insertion of the mating terminal. The bottom wall 12 is connected between lower side edges of the pair of side walls 13, and the other side of the top wall 11 is connected to an upper side edge of the other side wall 13.

As shown in FIG. 8, in the illustrated embodiment, the terminal 1 further includes a resilient cantilever 16 located in the insertion cavity 101 of the mating portion 10 and having a fixed end 16a connected to an inner side of a front end of one of the pair of side walls 13. The resilient cantilever 16 is used for electrical contact with the mating terminal inserted into the insertion cavity 101 of the mating portion 10. In the illustrated embodiment, a free end 16b of the resilient cantilever 16 abuts against an inner side of the rear end of the top wall 11, and a first electrical contact 16c is formed on the resilient cantilever 16, the first electrical contact 16c is used for electrical contact with a side of the inserted mating terminal. In the illustrated embodiment, the resilient cantilever 16 is V-shaped, and includes a first arm portion 161 extending between the fixed end 16a and the first electrical contact 16c and a second arm portion 162 extending between the free end 16b and the first electrical contact 16c.

As shown in FIG. 8, in the illustrated embodiment, two raised second electrical contacts 12c are formed on an inner side of the bottom wall 12 of the mating portion 10, and the two second electrical contacts 12c are both in electrical contact with a side of the inserted mating terminal. In the illustrated embodiment, the two second electrical contacts 12c are spaced apart in the longitudinal direction Y of the mating portion 10, and the first electrical contact 16c is located between the two second electrical contacts 12c.

As shown in FIG. 6, in the illustrated embodiment, the terminal 1 further includes a crimping portion 19 for crimping onto a cable 2, wherein the crimping portion 19 is connected to the rear end of the mating portion 10 and extends rearward. In the illustrated embodiment, the crimping portion 19 includes a first crimping portion 191 and a second crimping portion 192. The first crimping portion 191 is used for crimping onto a conductor core 21 of the cable 2. The second crimping portion 192 is used for crimping onto an outer sheath 22 of the cable 2. The first crimping portion 19 is located between the mating portion 10 and the second crimping portion 192.

In the illustrated embodiment, the terminal 1 is a one-piece stamped part.

In another exemplary embodiment of the present invention, an electrical connection module is also disclosed. The electrical connection module includes a terminal 1 and a cable 2. The cable 2 has an end electrically connected to the terminal 1.

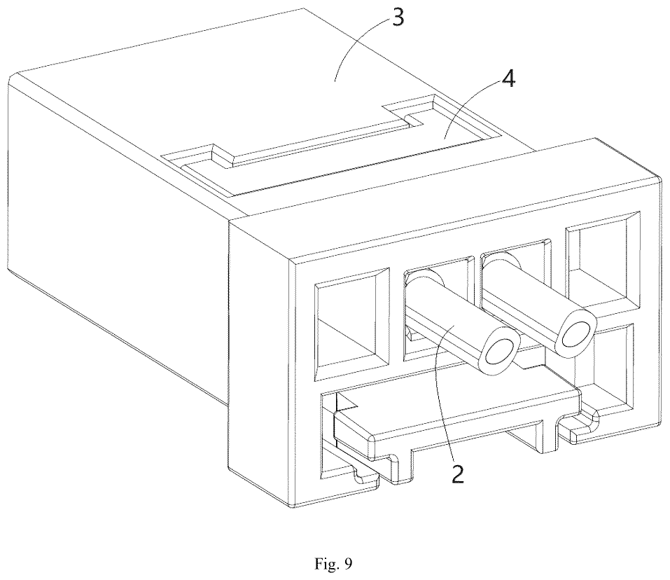

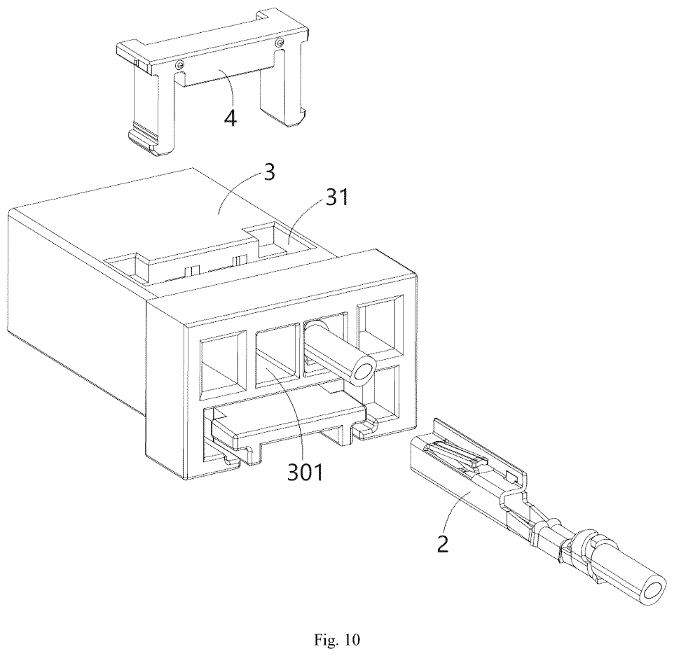

As shown in FIGS. 9 and 10, in another exemplary embodiment of the present invention, a connector is also disclosed. The connector includes a connector housing 3, a secondary lock 4 and the above terminal 1 or electrical connection module. The connector housing 3 has a terminal insertion hole 301 extending in a longitudinal direction Y thereof and a secondary lock slot 31 extending in a transverse direction X thereof and in communication with the terminal insertion hole 301. The terminal 1 or electrical connection module is inserted and mounted into the terminal insertion hole 301. The secondary lock 4 is inserted and mounted into the secondary lock slot 31 and abuts against the step portion 10a at the rear end of the mating portion 10 of the terminal 1 in the longitudinal direction Y to lock the terminal 1 in the terminal insertion hole 301.

In an embodiment, a guide groove extending in the longitudinal direction Y of the housing is formed in the housing, the guide groove is used for cooperating with the guide plate 14 on the terminal 1 to guide the insertion and mounting of the terminal 1 into the terminal insertion hole 301 of the connector housing 3 in a correct orientation.

As shown in FIG. 10, in the illustrated embodiment, a plurality of terminal insertion holes 301 are formed in the connector housing 3, and the secondary lock slot 31 is in communication with the plurality of terminal insertion holes 301. The connector includes a plurality of terminals 1, the plurality of terminals 1 are respectively inserted and mounted into the plurality of terminal insertion holes 301, and the secondary lock 4 is adapted to abut against all of the plurality of terminals 1 to lock all of the plurality of terminals 1 in the terminal insertion holes 301.

In the aforementioned exemplary embodiments according to the present invention, a rear end of one side wall of a mating portion of a terminal engages with a rear end of a guide plate and/or a rear end of a top wall, so that a rear end of the mating portion has a circumferentially closed annular structure, enhancing the structural strength of the rear end of the mating portion and thus enabling the terminal to be reliably locked in the housing by a secondary lock.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal, comprising:
a mating portion for mating with a mating terminal, the mating portion including a top wall and a bottom wall opposite the top wall in a height direction of the mating portion, and a pair of side walls opposite in a transverse direction of the mating portion; and
a guide plate connected to a side of the top wall, extending in a longitudinal direction of the mating portion, and guiding insertion of the terminal into a terminal insertion hole of a connector housing in a correct orientation, a step portion adapted to abut against a secondary lock of a connector is formed at a rear end of the mating portion, the terminal is locked in the terminal insertion hole by the secondary lock, the guide plate is located above and perpendicular to the top wall, a rear end of one of the side walls engages a rear end of the guide plate and/or a rear end of the top wall.

2. The terminal according to claim 1, wherein a snap is formed on the rear end of the one of the side walls, the snap protrudes upward from an upper side edge of the one of the side walls, a snap slot is formed in the rear end of the guide plate, the snap is latched into the snap slot to engage the rear end of the one of the side walls with the rear end of the guide plate.

3. The terminal according to claim 2, wherein the snap and the snap slot are rectangular, an engagement hole is formed in the snap, an engagement post is formed on a side of the rear end of the top wall, the engagement post is inserted into the engagement hole to engage the rear end of the one of the side walls with the rear end of the top wall.

4. The terminal according to claim 2, wherein the snap and the snap slot are L-shaped, T-shaped or Ω-shaped, the snap and the snap slot latched together are prevented from disengaging in the longitudinal direction and the height direction of the mating portion.

5. The terminal according to claim 1, further comprising a locking tab connected to a front end of the top wall and extending obliquely upward and rearward for engaging with a hole wall of the terminal insertion hole to lock the terminal in the terminal insertion hole.

6. The terminal according to claim 5, wherein an opening is formed in the top wall of the mating portion, the locking tab is suspended in the opening to allow the locking tab to move elastically in the height direction of the mating portion.

7. The terminal according to claim 1, wherein the top wall, the bottom wall and the pair of side walls of the mating portion define an insertion cavity receiving the mating terminal, the bottom wall is connected between a pair of lower side edges of the pair of side walls, another side of the top wall is connected to an upper side edge of the other of the side walls.

8. The terminal according to claim 7, further comprising a resilient cantilever located in the insertion cavity of the mating portion and having a fixed end connected to an inner side of a front end of one of the pair of side walls, the resilient cantilever electrically contacts the mating terminal inserted into the insertion cavity of the mating portion.

9. The terminal according to claim 8, wherein a free end of the resilient cantilever abuts against an inner side of the rear end of the top wall, a first electrical contact is formed on the resilient cantilever and electrically contacts a side of the mating terminal.

10. The terminal according to claim 9, wherein the resilient cantilever is V-shaped and includes a first arm portion extending between the fixed end and the first electrical contact and a second arm portion extending between the free end and the first electrical contact.

11. The terminal according to claim 9, wherein a pair of raised second electrical contacts are formed on an inner side of the bottom wall of the mating portion, the pair of second electrical contacts are both in electrical contact with a side of the mating terminal.

12. The terminal according to claim 11, wherein the second electrical contacts are spaced apart in the longitudinal direction of the mating portion, the first electrical contact is located between the second electrical contacts.

13. The terminal according to claim 1, further comprising a crimping portion crimping onto a cable, the crimping portion is connected to the rear end of the mating portion and extends rearward.

14. The terminal according to claim 13, wherein the crimping portion includes a first crimping portion crimping onto a conductor core of the cable and a second crimping portion crimping onto an outer sheath of the cable, the first crimping portion is located between the mating portion and the second crimping portion.

15. The terminal according to claim 1, wherein the terminal is a one-piece stamped part.

16. An electrical connection module, comprising:
a terminal including:
a mating portion for mating with a mating terminal, the mating portion including a top wall and a bottom wall opposite the top wall in a height direction of the mating portion, and a pair of side walls opposite in a transverse direction of the mating portion; and
a guide plate connected to a side of the top wall, extending in a longitudinal direction of the mating portion, and guiding insertion of the terminal into a terminal insertion hole of a connector housing in a correct orientation, a step portion adapted to abut against a secondary lock of a connector is formed at a rear end of the mating portion, the terminal is locked in the terminal insertion hole by the secondary lock, the guide plate is located above and perpendicular to the top wall, a rear end of one of the side walls engages a rear end of the guide plate and/or a rear end of the top wall; and
a cable having an end electrically connected to the terminal.

17. A connector, comprising:
a connector housing having a terminal insertion hole extending in a longitudinal direction of the connector housing and a secondary lock slot extending in a transverse direction of the connector housing, the secondary lock slot is in communication with the terminal insertion hole;
a terminal inserted and mounted into the terminal insertion hole, the terminal including:
a mating portion for mating with a mating terminal, the mating portion including a top wall and a bottom wall opposite the top wall in a height direction of the mating portion, and a pair of side walls opposite in the transverse direction; and
a guide plate connected to a side of the top wall, extending in the longitudinal direction, and guiding insertion of the terminal into the terminal insertion hole in a correct orientation, a step portion is formed at a rear end of the mating portion, the guide plate is located above and perpendicular to the top wall, a rear end of one of the side walls engages a rear end of the guide plate and/or a rear end of the top wall; and
a secondary lock inserted and mounted into the secondary lock slot and abutting against the step portion at the rear end of the mating portion of the terminal in the longitudinal direction to lock the terminal in the terminal insertion hole.

18. The connector according to claim 17, wherein a guide groove extending in the longitudinal direction of the housing is formed in the housing, the guide groove cooperates with the guide plate on the terminal to guide the insertion and mounting of the terminal into the terminal insertion hole of the connector housing in the correct orientation.

19. The connector according to claim 17, wherein a plurality of terminal insertion holes are formed in the connector housing, the secondary lock slot is in communication with the plurality of terminal insertion holes.

20. The connector according to claim 19, further comprising a plurality of terminals respectively inserted and mounted into the plurality of terminal insertion holes, the secondary lock abuts against all of the plurality of terminals to lock all of the plurality of terminals in the terminal insertion holes.
